(19) United States
(12) Patent Application Publication
(10) Pub. No.: US 2007/0146728 A1
(43) Pub. Date: Jun. 28, 2007

(54) Method and device for detecting, determining and documenting damage, especially deformations in lacquered surfaces caused by sudden events

(76) Inventor: Erwin Pristner, Berlin (DE)

Correspondence Address: JORDAN AND HAMBURG LLP, 122 EAST 42ND STREET, SUITE 4000, NEW YORK, NY, 10168, US

(21) Appl. No.: 10/551,160

(22) PCT Filed: Apr. 2, 2004
(86) PCT No.: PCT/EP04/03545

§ 371 Date: Nov. 27, 2006

(30) Foreign Application Priority Data
Apr. 3, 2003 (EP) 03090091.4

(51) Int. Cl. G01B 11/24

(52) U.S. Cl. 356/612

(57) ABSTRACT

A method and a device for detecting, determining and documenting damage to painted surfaces, especially parts of the bodywork of vehicles, utilizes light from at least one heavily focusing light source directed to a test surface in a grid-type or raster-type manner to produce a surface image on a screen with the light reflected on the test surface of the vehicle, the image being detected by a capturing, evaluating and signal processing device. The surface damage therein is then determined according to a specific evaluation algorithm and outputted for objective documentation of the damage. Results are achieved by coordinated, controlled displacement and/or pivoting between the light source and screen and by means of a rotational and/or displacement and or pivoting movement of the vehicle, which is controlled in accordance with the displacement and/or pivoting, around or along the longitudinal and/or vertical axis thereof inside a load-bearing structure, wherein the respective surface area to be sensed is brought towards the light source in the reflection position and the screen and the capturing device are brought towards the reflected light in an imaging position and the movements of the light source, screen, capturing device and vehicle are controlled by a processor unit.

### BACKGROUND OF THE INVENTION

The invention relates to a method for recording, measuring, and documenting damages, in particular deformations such as depressions or the like, that are caused by sudden events, for instance hailstorms, to painted surfaces, in particular body parts of vehicles, in which the surface to be examined on the vehicle is scanned with light from at least one highly focusing light source in a lattice- or grid-pattern and with the light reflected on the surface, a surface image is produced on a screen, which is recorded by an evaluation and signal processing device and, the surface damages are thereby determined using a certain evaluation algorithm and are output for objectively documenting the damages.

The invention furthermore relates to an apparatus for recording, measuring, and documenting damages, in particular deformations such as depressions or the like that are caused by sudden events, for instance hailstorms, to painted surfaces, in particular body parts of vehicles, with a highly focusing light source for illuminating a surface having deformations or damages to painted body parts of a vehicle, a deflection device for the light for linear and grid-pattern scanning of the surface, a screen for imaging the surface by means of light beams reflected by the surface, recording device for recording the images, an image processor for processing and evaluating the images recorded, and a display/output device for displaying and outputting the results.

Frequently, especially in the summer months, it is not possible to shelter vehicles in sufficient time when there is a hailstorm. These vehicles, especially new or unused passenger vehicles, delivery trucks, or the like, sometimes suffer significant damages from depressions and/or dents on their roofs, hoods, trunk lids, fenders, doors, spoilers, sides, and/or roof rails. Small, barely visible dents particularly lower the sale or re-sale value of a passenger vehicle damaged in this manner. Insurance generally takes care of broken front and rear windshields and side windows in the settlement process. Even deep dents are agreeably settled after a proven hailstorm. However, small and barely visible depressions frequently lead to frustrating and acrimonious disagreements among the parties involved. In addition to the party that suffered the damages, other parties involved are the damage assessor, the claims adjuster for the insurance company, and especially the company that is to restore the value of the damaged automobile with appropriate repairs.

In the past no suitable measurement and evaluation method was available for damages caused by hailstorms to painted surfaces, in particular body parts of motor vehicles, that objectively described and documented the damages and also the quality of the repairs performed.

A method is described in DE 24 39 988 A for recording locally-limited deformations on curved surfaces, in particular on surfaces of pressed body parts for motor vehicles, in which the surface to be examined is scanned with bundled light in a lattice and grid pattern. The light lattice or grid is detected at a different angle than the angle of incidence of the light in the form of an image that is mathematically analyzed with respect to locally limited distortions to the lattice or grid. The light used comprises laser light. For performing the known method there is a light beam generator, a scanning device for guiding the light beam in a lattice- or grid-pattern over the surface to be examined, a remote-control camera with monitor directed at the surface at a different angle than the light beam, and an analysis unit evaluating the image on the monitor.

Primarily, individual body parts or components are analyzed for deformations using this known solution. The method is tied to the production process, and is thus stationary and bound to the site. Its use on damages to vehicle bodies caused by sudden events like hailstorms has not been considered in the past because it is necessary to scan the entire vehicle body, for which the known technical teaching provides no solution, as there is not adequate mobility.

Given this prior art, it is an object of the invention to provide a method and an apparatus of the type cited in the foregoing, which makes it possible to objectively describe, evaluate, and document damages to painted surfaces, in particular bodies of motor vehicles, which damages are caused by sudden events such as hailstorms, and their repair.

This object is attained using a method in which at least one focused light source is reflected from a test surface of, for example, a vehicle, in a grid-type or raster-type manner to produce a surface image on a screen with the light reflected on the surface, the image being detected by a capturing, evaluating and signal processing device. The surface damage is then determined according to a specific evaluation algorithm and outputted for objective documentation of the damage. Results are achieved by coordinated, controlled displacement and/or pivoting between the light source and screen and by means of a rotational and/or displacement and or pivoting movement of the vehicle, which is controlled in accordance with the displacement and/or pivoting, around or along the longitudinal and/or vertical axis thereof inside a load-bearing structure, wherein the respective surface area to be sensed is brought towards the light source in the reflection position and the screen and the capturing device are brought towards the reflected light in an imaging position and the movements of the light source, screen, capturing device and vehicle are suitably controlled. An apparatus according to the invention includes a support frame in which an object, such as a vehicle having a painted surface, is receivable, the support frame including guide rails. A focused light source is provided for illuminating the surface with a light beam, the light source being mounted on the support frame such that it is displaceable along the guide rails and pivotable horizontally and/or vertically. A screen for forming an image of the surface by the light beam reflected by the surface is mounted on the support frame such that it is displaceable along the guide rails and is pivotable, and a recording device is provided for recording the images. A measurement table to which the object is anchorable is rotatable about a longitudinal axis thereby allowing each position of the painted surface of the object to be brought into a reflection position with respect to the light source and the screen. A processor unit is operable to correlate and coordinate movements of the light source, the screen, and the object, and an evaluation and signal processing device creates results by processing and evaluating the images recorded. The results are displayed and/or outputted on a display and/or an output device.

The method according to the invention makes it possible to objectively measure, record, and document, for all parties involved, damages, such as small surface-area depressions to painted body parts, which damages were caused by hail storms. Furthermore, appropriate repair and maintenance of the damaged vehicle can be demonstrated with the inventive solution. Of particular advantage is the mobility attained with the inventive solution, by virtue of which, it is possible to undertake a cause-related damage assessment within a short period of time after a hailstorm strikes.

By using a focused light beam, for example, a laser beam with a small spot diameter, a precise image of the damaged surface with very high resolution can be attained. The inventive method furthermore attains a very high scanning speed so that the entire surface of a body can be imaged and analyzed in a very short period of time.

The apparatus according to an embodiment of the invention furthermore realizes a simple, robust, and yet safe scanning concept with laser light sources that can travel and pivot horizontally and vertically along braces of a support frame, and whose movement is coordinated with the movement of the vehicle. Thus, the entire body surface can be inspected, imaged, analyzed, and certified for damages in a single work step.

According to embodiment of the invention, apparatuses can be produced which are compact and simple in structure. The functional units are easily understood and arranged freely accessible for assembly and maintenance purposes.

The invention shall be explained in greater detail in the following using a number of exemplary embodiments.

### BRIEF DESCRIPTION OF THE DRAWINGS

FIG. 1 is a schematic representation of the method according to the invention that illustrates the principle thereof;

FIG. 2 illustrates the typical beam path for the laser beams on a deformed body surface; and

FIG. 3 is a perspective view depicting a variant of the support frame with integrated inventive apparatus.

### DETAILED DESCRIPTION OF THE INVENTION

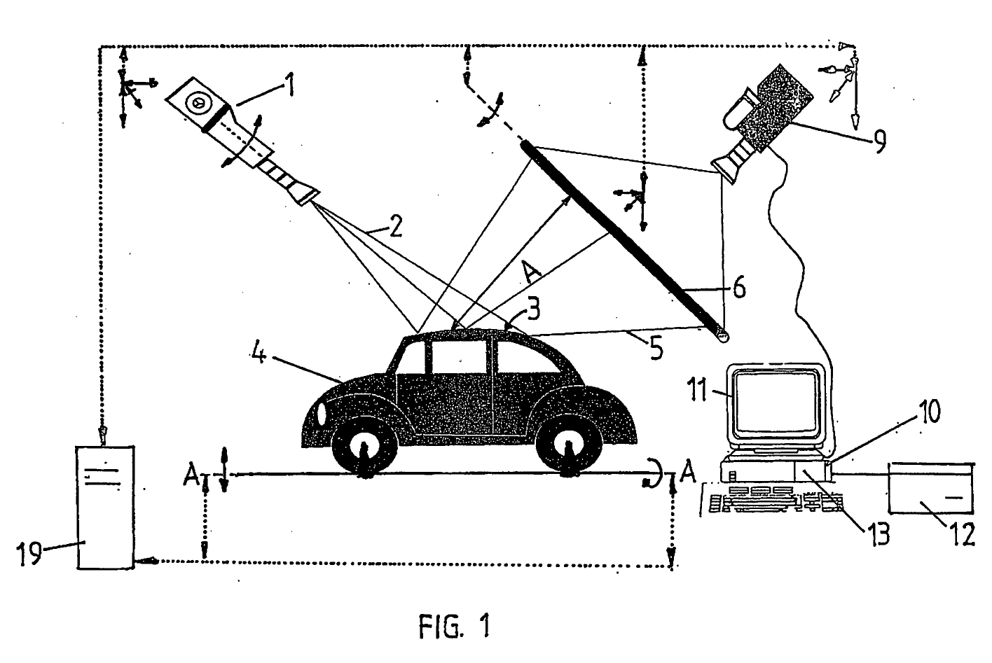

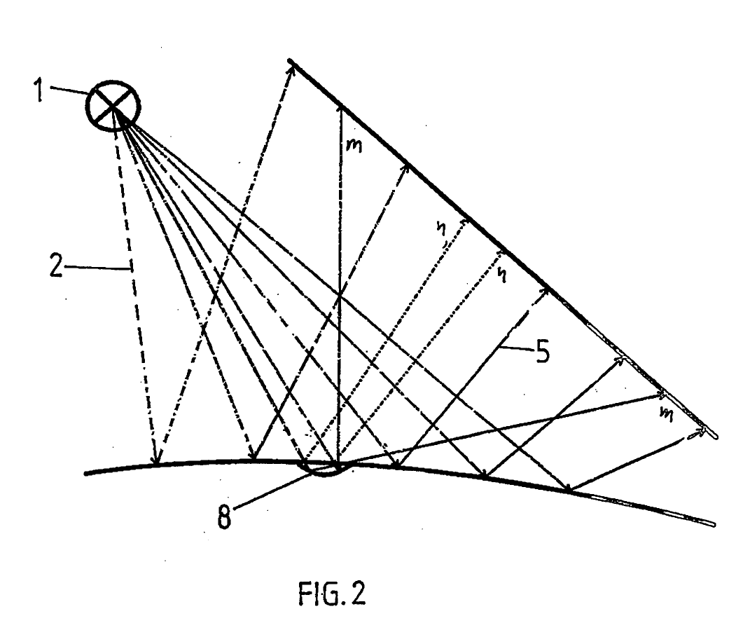

FIG. 1 is a schematic depiction of the principle of the inventive method in which the damages to the roof of a passenger vehicle, for example, caused by a hailstorm, are to be determined, evaluated, and documented. High-gloss painted surfaces reflect laser light striking them. The laser light beam 2 produced by a surface scanner 1 is directed onto the surface 3 of the vehicle 4 to be examined and is guided over the surface 3 using a conventional deflection device. The laser light beam 2 strikes the surface 3 and is reflected therefrom in a manner corresponding to the Law of Reflection in optics, according to which, the angle of incidence is equal to the angle of reflection relative to the surface normals of the just stricken surface element. The reflected laser light beam 2 strikes a flat screen 6 on which the scanned surface becomes visible. The accuracy of the image and the recognizability of small details is largely a function of the diameter of the laser light beam 2, wherein the smaller the diameter of the laser light beam 2, the higher the resolution. Thus, for the inventive method, the advantages of laser engineering for simply generating highly bundled light are fully utilized. This does not mean, however, that the method according to the invention is limited to laser light. On the contrary, the invention also includes the use of other light sources, provided these are suitable for self-focusing. If the laser light beam 2 moves over the surface 3 to be examined, a line 7 appears on the screen 6 that represents a precise image of the line traveled on the surface 3. Even the smallest local deviations from the surface lead to clear notches in the otherwise uniform line of an undamaged surface. If the screen 6 is positioned at a farthest possible distance A from the surface 3 to be examined, a corresponding enlargement of the image can be obtained. A uniform curve in the surface, as occurs for instance on a vehicle roof or fender, is likewise imaged as a continuously curved line. If there are depressions in the surface 3, these disturbances to the surface become visible due to notches in the line. This is depicted in FIG. 2, which illustrates a typical path for a beam on a deformed body surface. In FIG. 2, n indicates the beam path with a depression 8 and m indicates the beam path without a depression 8 in the surface 3.

A recording device is assigned to the screen 6, for example, a digital camera 9, that is used to digitally record the image of the surface 2 produced by the surface scanner 1. The digital image information is forwarded from the digital camera 9 to an evaluation and signal processing device 10 for storage, based upon which, device analysis is performed for determining the damage. The evaluation results are displayed on the monitor 11 and output with a printer 12 (examples of display and output devices, respectively) as a measurement record.

In the present example illustrated in FIG. 1, the surface 3 of the entire vehicle roof is scanned and recorded as image information and stored in the microprocessor 13 of the evaluation and signal processing device 10.

Characteristic image information for an undisturbed surface 3 of a comparable body is stored in the microprocessor. The measured image information is compared to characteristic image information. The degree of the deviation between the measured surface profile and the comparison signature for the undisturbed surface is a measure for the type and scope of damage.

### EXAMPLE 1

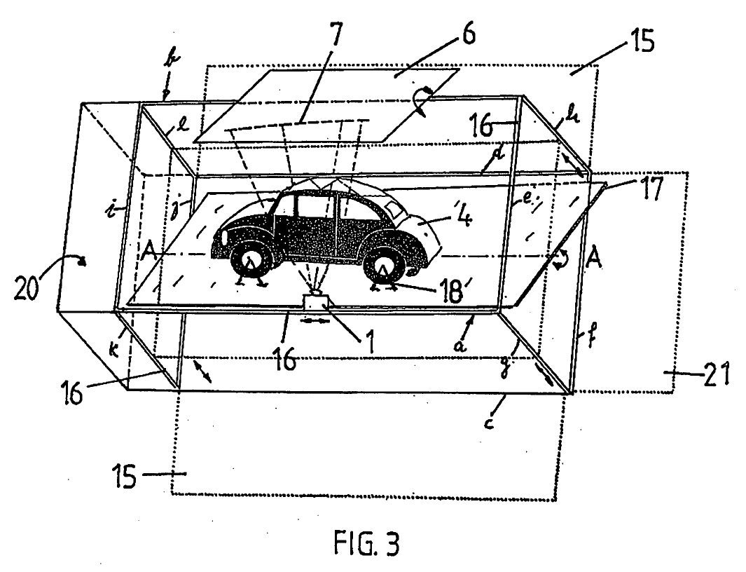

FIG. 3 illustrates the design of the inventive method within a container-like support frame 14 in which the vehicle 4 to be tested is situated.

This support frame 14 largely comprises the upper lateral braces a and b, the lower lateral braces c and d, the front end braces e, f, g, and h, and the rear end braces i, j, k, and l, assembled. One of each type of side brace, a vertical and a horizontal side brace, are joined to one another in a surface fit using corner fittings. The side walls are pivotably hinged at the lower side braces c and d and the lower side braces f and j so that at the set-up location the support frame 14 is freely accessible on all sides by opening the side walls 15 and end wall 21.

Mounted along the upper side braces a and b, the front upper horizontal and vertical end braces e, g, and h, and the rear horizontal and vertical end braces i, k, and l, are guide rails 16 that guide the surface scanner 1 and the screen 6. The surface scanner 1 is driven for instance by a step motor (not shown), and is moved horizontally and vertically in the guide rails 16. The surface scanner can also make a pivoting movement using an appropriate tilt apparatus. An argon or krypton ion laser with output capacity in the range of a few 100 mW in the TEMoo mode and a spot diameter of less than 0.5 mm is used so that structural differences of <0.5 mm can be detected and documented. Given a linear distance of 0.5 mm, as well, depressions 8 of this magnitude can be analyzed. For instance, a surface area of 2 m ×2 m can be scanned in a few seconds using a beam excursion of +/−1000 mm both in the longitudinal and in the transverse direction.

Even with a line deflection frequency of 1000 Hz, at a line feed of 0.5 mm on a length of 2 m, only 4000 lines have to be traveled. This means that in 4 seconds a complete image of the 4-m² surface is available on the screen 6.

The vehicle 4 to be examined drives into the support frame 14 onto a measurement table 17, and is anchored there by means of fasteners 18 that are attached to the measurement table. Using a lifting mechanism (not shown), the measurement table 17 and the vehicle 4 are lifted to a height at which the vehicle can perform a pivoting or rotational movement about its longitudinal axis A-A with no problem.

A screen 6 made, for example, of matte glass is suspended in the guide track 16 opposing the surface scanner land set up at an angle inclined −45° such that the entire surface of the vehicle 4 can be imaged on the screen 6.

The vehicle 4 together with the measurement table 17 is then pivoted or caused to rotate about the longitudinal axis A-A using a suitable drive so that the surface 3 of the vehicle 4 reflects the laser beams emitted by the surface scanner 1 and are deflected to the screen 6. A digital camera is assigned to the screen 6 that has been omitted in FIG. 3 for reasons of simplicity (see also FIG. 1 for analogous depiction). Processing, evaluation, and documentation of the scanned surface 3 of the vehicle 4 is performed corresponding to the process described in the foregoing. The drive assemblies for the displacing and pivoting movement of the surface scanner 1 and the screen 6, and for the rotational or pivoting movement by the vehicle 4 are controlled by a separate processor unit 19 so that it is assured that the movements correlate for scanning the body surface.

The evaluation and signal processing unit 10, monitor 11, printer 12, microprocessor 13, and processor unit 19 for the coordinated control of the drives are located in a separate space 20 (a communication and operator space) that is divided off from the support frame 14. Once the measurements and evaluations have concluded, the vehicle 4 together with the measurement table 17 is lowered, the measurement table 17 is locked, the vehicle 4 is released from its anchoring and driven out of the support frame 14. When the side walls 15 and end wall 21 are flipped up, the support frame 14 is closed on all sides and thus after it is loaded onto a truck or semi-trailer truck it can be taken to the next location.

### EXAMPLE 2

The structure of the inventive apparatus in Example 2 is largely the same as that in Example 1. The difference is that the vehicle 4 is not lifted and does not make a rotational or pivoting movement. The body surface is scanned in that, for an immobile or moved vehicle, only the surface scanner 1 performs a displacement movement in the horizontal and vertical direction, and the screen 6 is brought into the corresponding intercepting position for the reflected laser light beams 2.

Key to reference numbers used

| | |
|---|---|
| Light source, surface scanner | 1 |
| Laser light beam | 2 |
| Surface of body | 3 |
| Vehicle | 4 |
| Reflected beams | 5 |
| Screen | 6 |
| Line | 7 |
| Depression | 8 |
| Digital camera | 9 |
| Evaluation and signal processing | 10 |
| unit | |
| Monitor | 11 |
| Printer | 12 |
| Microprocessor | 13 |
| Support frame | 14 |
| Side wall | 15 |
| Guide rails | 16 |
| Measurement table | 17 |
| Fasteners | 18 |
| Processor unit | 19 |
| Communication and operator | 20 |
| space for 14 | |
| End wall | 21 |
| Distance from surface to screen | A |
| Longitudinal axis of vehicle 4 | A—A |
| Upper lateral braces for 14 | a, b |
| Lower lateral braces for 14 | c, d |
| Front side braces for 14 | e, f, g, h |
| Rear end braces for 14 | i, j, k, l |
| Path of beam with depression 8 | m |
| Path of beam without depression | n |

1-32. (canceled)

33. An apparatus for recording, measuring, and documenting damages to an object having a painted surface, comprising:
a support frame in which the object is receivable, said support frame including guide rails;
a focused light source for illuminating the surface with a light beam, said light source being mounted on said support frame such that said light source is displaceable along said guide rails and pivotable at least one of horizontally or vertically;
a screen for forming an image of the surface by the light beam reflected by the surface, said screen being mounted on said support frame such that said screen is displaceable along said guide rails and is pivotable;
a recording device for recording the images;
a measurement table to which the object is anchorable, said measurement table being rotatable about a longitudinal axis thereby allowing each position of the painted surface of said object to be brought into a reflection position with respect to said light source and said screen;
a processor unit for correlating and coordinating movements of the light source, the screen, and the object;
an evaluation and signal processing device for creating results by processing and evaluating the images recorded; and
at least one of a display or an output device for displaying and/or outputting the results.

34. An apparatus according to claim 33, wherein said object is a vehicle comprising body parts.

35. An apparatus according to claim 33, wherein said damages include depressions caused by sudden events.

36. An apparatus according to claim 34, wherein:
said support frame includes horizontal or vertical braces; and
said support frame is a container support frame including side walls and end walls which are pivotable about said horizontal or vertical braces thereby defining a support frame that is open on the end walls and side walls for accommodating and scanning said vehicle.

37. An apparatus according to claim 34, wherein said braces of said support frame are embodied such that they can be lockably assembled.

38. An apparatus according to claim 34, wherein said support frame further includes at least one of a communications space or an operator space separated off from said support frame in which said evaluation and signal processing unit, said display or said output device, and said processor unit are located.

39. An apparatus according to claim 36, wherein said support frame further includes at least one of a communications space or an operator space separated off from said support frame in which said evaluation and signal processing unit, said display or said output device, and said processor unit are located.

40. An apparatus according to claim 38, wherein said communications and operator space is heat- and sound-insulated.

41. An apparatus according to claim 39, wherein said communications and operator space is heat- and sound-insulated.

42. An apparatus according to claim 34, wherein said support frame is part of a mobile vehicle.

43. An apparatus according to claim 36, wherein said mobile vehicle includes a truck or a mobile container frame.

44. An apparatus according to claim 34, wherein said light source is a laser light, pulsed flashlight, or infrared light.

45. An apparatus according to claim 44, wherein said laser light is a gas laser such as an excimer laser, argon ion laser, chemical laser, CO laser, CO₂ laser, optically pumped molecular laser, solid state laser, or semiconductor laser.

46. An apparatus according to claim 34, wherein said screen is a mesh, matte glass pane, light-sensitive plate, or self-reflecting projection wall.

47. An apparatus according to claim 34, wherein said screen is an electro-optical receiver.

48. An apparatus according to claim 34, wherein said electro-optical receiver includes a diode array.

49. An apparatus according to claim 34, wherein:
the light scans said surface to be scanned in lines; and
an advance when the light beam is displaced is smaller than a light beam diameter.

50. An apparatus according to claims 34, wherein the reflected light beams are deflectable directly onto said screen with simultaneous enlargement of the image scale of said surface.

51. An apparatus according to claim 34, wherein said recording device for recording the surface image includes a photographic camera, a digital camera, or a web cam.

52. An apparatus according to claim 1a, wherein said display and said output device include a monitor and printer, respectively.
